(19) United States
(12) Patent Application Publication
(10) Pub. No.: US 2026/0046033 A1
(43) Pub. Date: Feb. 12, 2026

(54) SILICON PHOTONIC SHARED LASER WITH SEMICONDUCTOR OPTICAL AMPLIFIERS

(71) Applicant: OpenLight Photonics, Inc., Goleta, CA (US)

(72) Inventors: John Parker, Goleta, CA (US); Molly Piels, Santa Barbara, CA (US); Hanxing Shi, Sunnyvale, CA (US)

(21) Appl. No.: 18/798,092

(22) Filed: Aug. 8, 2024

(51) Int. Cl. H04B 10/54; H04B 10/032; H04B 10/079; H04B 10/50; H04J 14/02

(52) U.S. Cl. CPC H04B 10/541; H04B 10/032; H04B 10/07955; H04B 10/503; H04J 14/0307

(57) ABSTRACT

A multi-lane optical transmitter includes an optical splitter to receive light generated by at least one laser and split the light into a plurality of portions. A plurality of semiconductor optical amplifiers (SOAs) are configured to receive respective portions of the light and amplify the portions to generate amplified light. The optical transmitter also includes a plurality of outputs configured to output portions of the amplified light generated by the SOAs. Examples can include modulators to modulate the light in each lane.

### TECHNICAL FIELD

The present disclosure generally relates to optical devices and more particularly to optical sources.

### BACKGROUND

In an optical transmitter, the laser or other optical source driving the transmitter uses the majority of the power. Multi-lane transmitters require a separate laser for each lane or a single very-high-power laser with its output split to drive the multiple lanes, further increasing power requirements. In order to reduce datacenter power consumption, it is necessary to reduce the power consumption of optical modules incorporating optical transmitters.

### BRIEF DESCRIPTION OF THE SEVERAL VIEWS OF THE DRAWINGS

The following description includes discussion of figures having illustrations given by way of example of implementations of embodiments of the disclosure. The drawings should be understood by way of example, and not by way of limitation. As used herein, references to one or more “examples” or “embodiments” are to be understood as describing a particular feature, structure, or characteristic included in at least one implementation of the inventive subject matter, in at least some circumstances. Thus, phrases such as “in one example”, “in some examples”, “in some embodiments”, “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number may refer to the figure (“FIG. ”) number in which that element or act is first introduced.

FIG. 1 (Prior Art) is a block diagram of a first conventional optical transmitter architecture having multiple integrated lasers.

FIG. 2 (Prior Art) is a block diagram of a second conventional optical transmitter architecture having a single high-power external laser.

FIG. 3 is a block diagram of a first optical transmitter having a shared laser and semiconductor optical amplifiers (SOAs), in accordance with some examples of the present disclosure.

FIG. 4 is a block diagram of a second optical transmitter having a shared laser and SOAs positioned after modulators, in accordance with some examples of the present disclosure.

FIG. 5 is a flowchart showing operations of a method for operating an optical transmitter with SOAs, in accordance with some examples of the present disclosure.

FIG. 6 is a block diagram of a third optical transmitter having a shared laser and redundant backup SOAs, in accordance with some examples of the present disclosure.

FIG. 7 is a block diagram of a controller in communication with components of an optical transmitter, in accordance with some examples of the present disclosure.

FIG. 8 is a block diagram of a fourth optical transmitter having a shared laser and shared backup SOAs between each pair of primary SOAs, in accordance with some examples of the present disclosure.

FIG. 9 is a flowchart showing operations of a method for operating an optical transmitter with backup SOAs, in accordance with some examples of the present disclosure.

FIG. 10 is a block diagram of a fifth optical transmitter having a shared laser and backup SOAs after the modulators, in accordance with some examples of the present disclosure.

FIG. 11 is a block diagram of a laser module for a sixth optical transmitter having 8 lasers and shared backup SOAs, in accordance with some examples of the present disclosure.

FIG. 12 is a block diagram of a laser module for a seventh optical transmitter having 16 lasers and shared backup SOAs, in accordance with some examples of the present disclosure.

FIG. 13 is a block diagram of a laser module for an eighth optical transmitter having 16 lasers, a multiplexer, and shared backup SOAs, in accordance with some examples of the present disclosure.

FIG. 14 is a flowchart showing operations of a method for calibrating and operating an optical transmitter with SOAs, in accordance with some examples of the present disclosure.

Descriptions of certain details and implementations follow, including a description of the figures, which may depict some or all of the embodiments described below, as well as discussing other potential embodiments or implementations of the inventive concepts presented herein. An overview of example embodiments of the disclosure is provided below, followed by a more detailed description with reference to the drawings.

### DETAILED DESCRIPTION

In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, structures, and techniques are not necessarily shown in detail.

Examples described herein attempt to address the technical problem of reducing power consumption of an optical transmitter by using semiconductor optical amplifiers (SOAs) to amplify the power of one or more lasers driving the transmitter. In some examples, a single laser has its output split into multiple lanes, resulting in coherent light of relatively low optical power driving each lane. To increase optical power, the lanes are amplified by SOAs, which are generally more power-efficient than lasers (in terms of wall plug efficiency) for increasing the optical power of each lane. In some examples, multiple lasers operating at multiple wavelengths have their outputs combined, and this combined output is then split and amplified by SOAs. Either internal lasers or external lasers can be used in various different examples.

In some cases, the use of power-efficient SOAs to amplify optical power results in decreased reliability, because the SOAs have a higher chance of failure and a shorter lifetime than lasers when driven at a high drive current sufficient to achieve the desired optical power level for each lane. Thus, in some examples, each primary SOA used to drive one or more lanes of the transmitter can be paired with a backup SOA, which can be activated in response to failure of the primary SOA. In other examples, a single backup SOA can be shared by every pair of two adjacent primary SOAs. Because SOA failure is generally random over the lifetime of a device, with perhaps a random subset of 10% of SOAs failing over the expected lifetime of the device as a whole, providing a backup SOA to each primary SOA, or to each pair of adjacent primary SOAs, may be effective to eliminate or mitigate premature SOA failure as a cause of device failure.

Some prior approaches to increased reliability of optical transmitters have included the use of additional backup lasers that can be activated in the event of failure of the primary laser. However, this does not solve the problem of lower laser efficiency relative to SOA efficiency. Examples described herein may instead use a laser operated at a relatively low drive current to extend laser lifetime, then split the laser's output and amplify each portion of the output using SOAs.

Some examples described herein may benefit from additional design considerations to address complications that may arise from the use of SOAs to amplify the optical power of the transmitter outputs. For example, an SOA can introduce additional reflections back toward the laser; this effect can be mitigated by various techniques in different example embodiments, such as angled facets and/or anti-reflective coatings applied to the photonic integrated circuit (PIC) incorporating the transmitter.

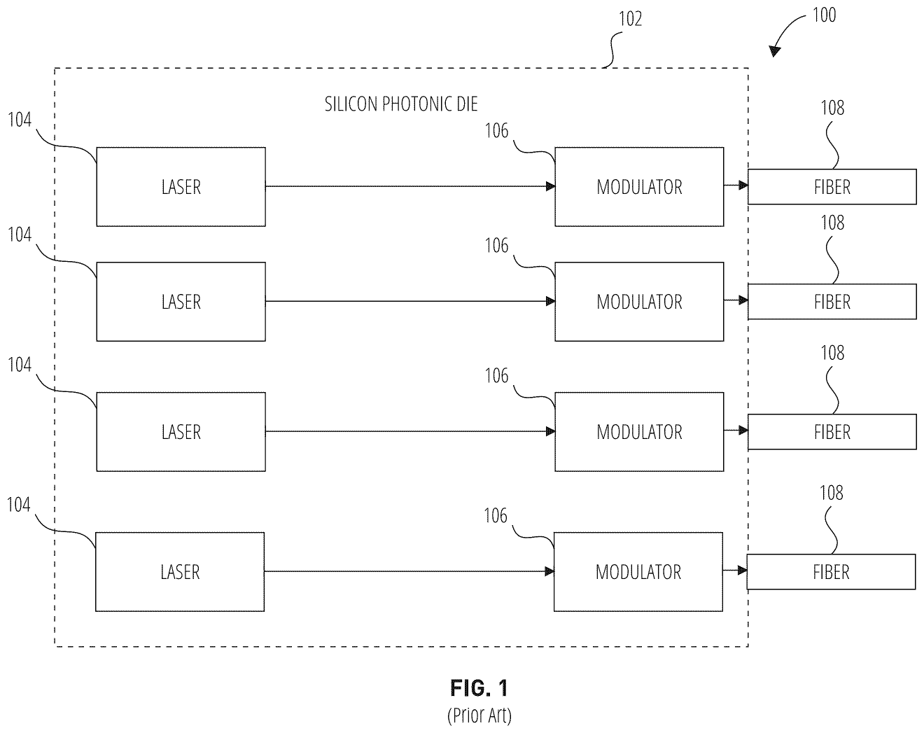

FIG. 1 shows a first conventional optical transmitter 100 architecture having multiple integrated lasers. The first conventional optical transmitter 100 illustrates a conventional approach to designing a multi-lane optical transmitter. In this example, the transmitter is implemented on a PIC, shown as silicon photonic die 102. The silicon photonic die 102 has multiple outputs, each coupled to an optical link such as an optical fiber 108 suitable for carrying optical transmissions.

An array of multiple lasers 104 (e.g., four lasers) is operated at a relatively high current to generate coherent light from each laser 104 at a relatively high optical power, such as 20 milliwatts (mW) per laser 104. The light generated by each laser 104 is modulated by a respective modulator 106 (e.g., to encode data in the optical signal carried on a respective optical channel), and the modulated light is provided via an output of the transmitter The modulated light output by each modulator 106 to each fiber 108 may experience significant loss relative to the laser output: for example, each fiber 108 may receive light having optical power of only 2 mW, reflecting an optical power loss of 90%.

As described above, this first conventional optical transmitter 100 requires multiple lasers 104 operating at moderately high drive currents to drive output lanes at relatively low optical power. This may result in high power consumption, short laser lifetimes, and/or high device complexity (due to the need for multiple internal lasers).

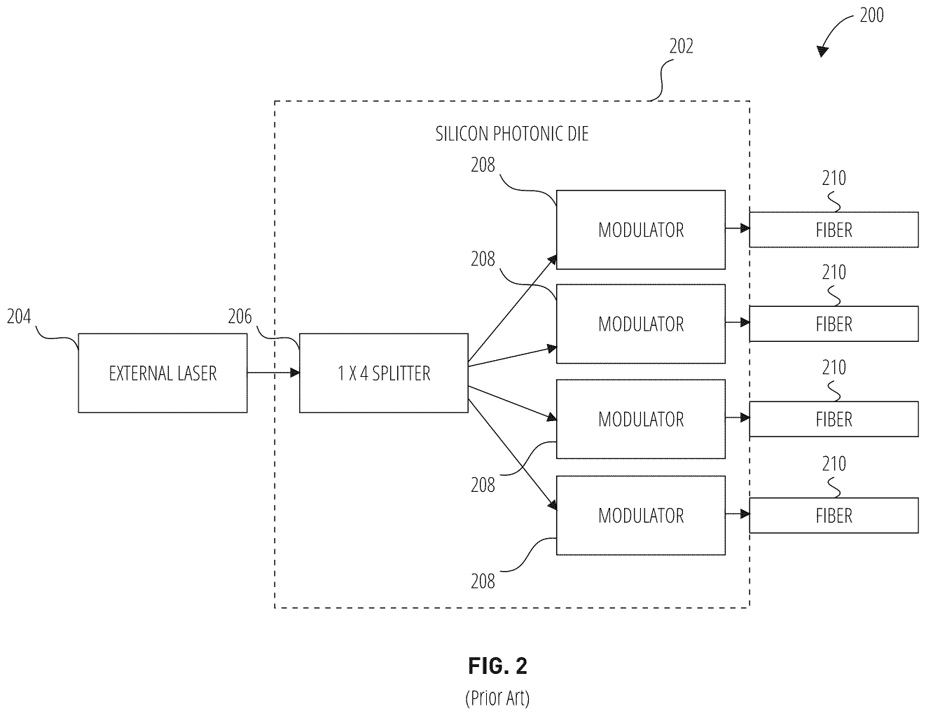

FIG. 2 shows a second conventional optical transmitter 200 architecture having a single high-power external laser. In this example, a single external laser 204 (external to the silicon photonic die 202) is operated at a very high drive current to generate coherent light having high optical power (e.g., 100 mW). A power splitter, shown as a 1×4 splitter 206 in this example, is used to split the laser output into four lanes modulated by four modulators 208. The optical power loss after splitting and modulating the laser output results in each fiber 210 receiving an output from the transmitter in the same general range as the first conventional optical transmitter 100 described above, e.g., 2 mW per output lane.

This approach may result in very high power consumption and short lifetime for the external laser 204.

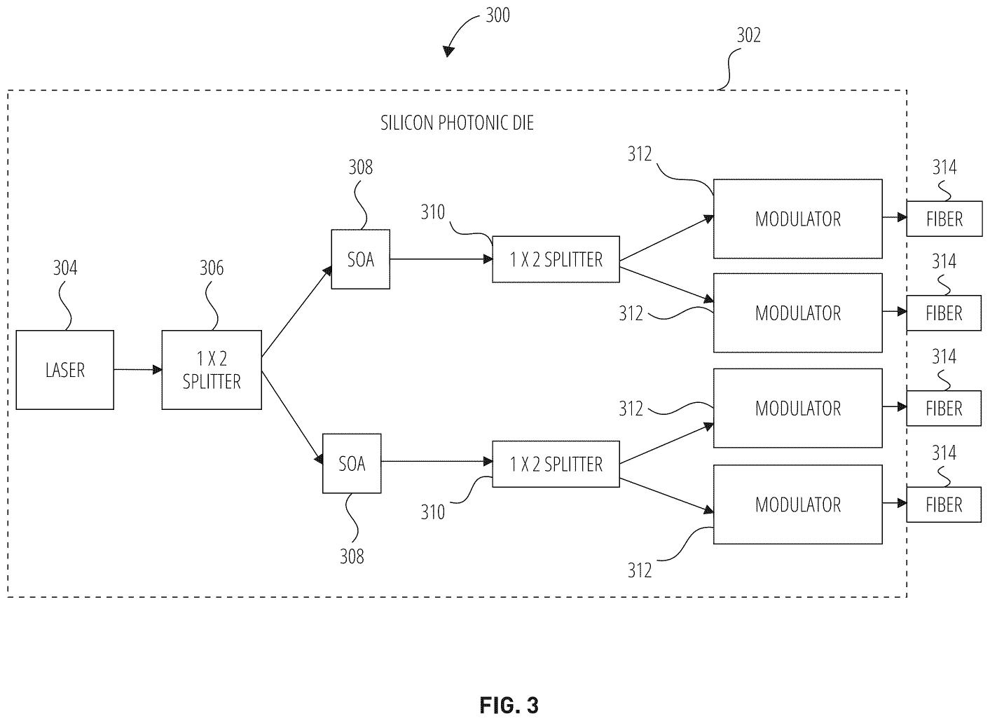

FIG. 3 shows a first optical transmitter 300 illustrating the amplification techniques described herein. A shared laser 304 generates coherent light that is split into multiple portions by a power splitter (e.g., a power splitter with one input and two outputs, shown as 1×2 splitter 306). Each portion of the light split by the 1×2 splitter 306 is amplified by a respective SOA 308 (in this example, two SOAs 308). The amplified light generated by each SOA 308 is then split again into multiple portions (also referred to as sub-portions) by a further respective power splitter (e.g., a further 1×2 splitter 310), and each of these portions drives a respective output lane. Each of these lanes (in this example, four lanes) is modulated by a respective modulator 312, and the modulated amplified light is provided to a respective output for transmission on a respective fiber 314.

In this example, each SOA 308 may be operated at relatively high optical output power to counteract losses from the splitters 306 and 310 and the modulators 312. For example, the laser 304 may be driven at a low drive current to generate light at, e.g., 10 mW, thereby lengthening its lifetime and reducing power consumption relative to the conventional designs described above. However, each SOA 308 may be driven by a relatively high drive current to apply relatively high gain to the light to generate amplified light at, e.g., 40 mW. After this amplified light is split by the 1×2 splitters 310 and modulated by the modulators 312, each fiber 314 may receive light from its corresponding output of the same optical power described above, e.g., 2 mW. Only two SOAs 308 are required to driver four lanes in this example, which may accordingly be highly power-efficient and simple to design.

In some examples, the high electrical drive currents applied to the SOAs 308 may shorten their operating lifetime. This possible limitation can be addressed in some examples by using backup SOAs, as described in greater detail below.

In this example, an internal laser 304 is shown integrated into the silicon photonic die 302 in or on which the other transmitter components are formed. However, in some examples described herein, the laser could be external to the silicon photonic die 302, as will be described in reference to various other examples below.

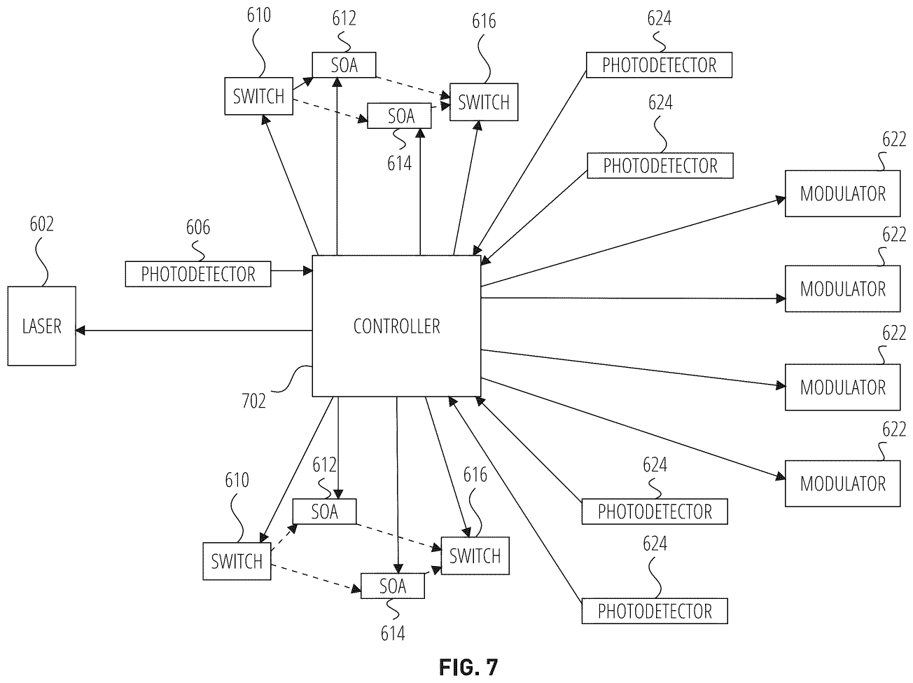

In some examples, photodetectors and taps can be included in the various light paths of the first optical transmitter 300 to monitor optical power at various locations. These can be used to calibrate the laser 304 and/or the SOAs 308, to provide feedback to the modulators 312, and/or to detect failure of one or more primary SOAs 308 in designs having backup SOAs. An example controller for controlling such operations is described in reference to FIG. 7 below.

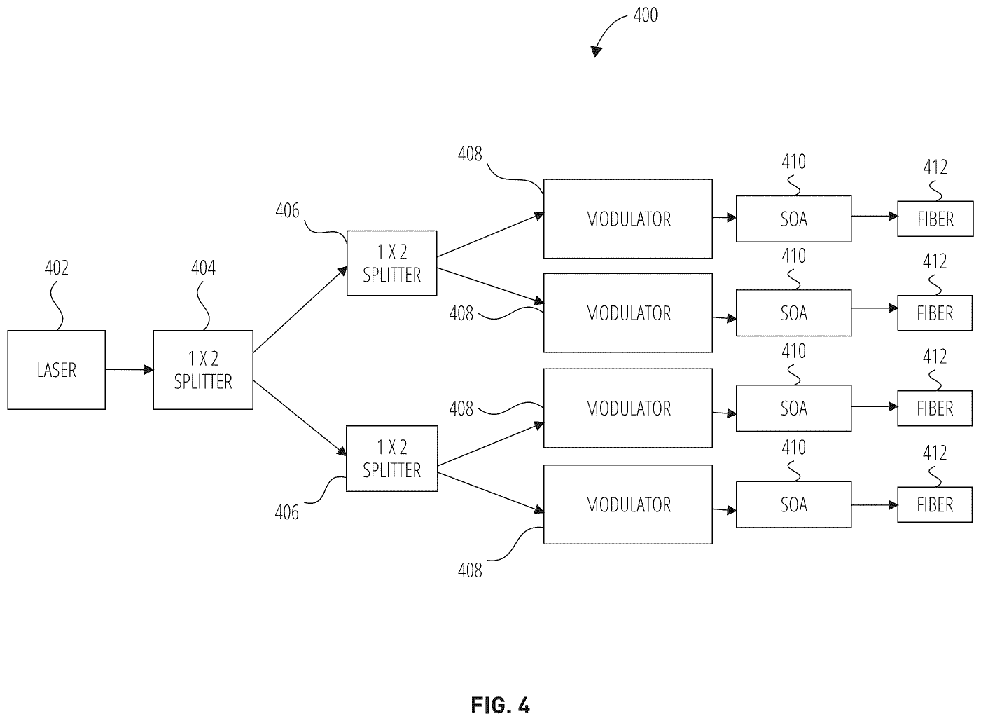

FIG. 4 shows a second optical transmitter 400 having a shared laser 402 and a separate SOA 410 for each output lane. In the second optical transmitter 400, the SOAs 410 are positioned after the modulators 408 instead of before the modulators 408.

Unlike the first optical transmitter 300, the second optical transmitter 400 uses a first 1×2 splitter 404 to split the output of the laser 402 into two portions before immediately using a second array of 1×2 splitters 406 to split each of these two portions into another two portions, thereby generating four portions of coherent light on four lanes. Each lane is modulated by a respective modulator 408, and the modulated light is amplified by a respective SOA 410 to generate amplified light, which is provided to each output for transmission on fibers 412.

Thus, the second optical transmitter 400 requires twice as many SOAs 410 as the first optical transmitter 300, but as a result generates output signals having higher optical power. For example, the laser 402 may generate coherent light at, e.g., 10 mW, which is split, modulated, and then amplified by the SOA 410 of each lane to generate amplified light on each fiber 412 of, e.g., 10 mW of optical power. Whereas this approach may be less power-efficient than the first optical transmitter 300 due to the larger number of SOAs, the second optical transmitter 400 may be suitable for certain long-reach applications where more power is needed per channel.

It will be appreciated that, in the examples described herein, the number and arrangement of splitters and SOAs can be reconfigured to operate various numbers of lanes with various levels of amplification. However, each output lane typically requires its own modulator in order for each lane to independently encode a separate channel of data.

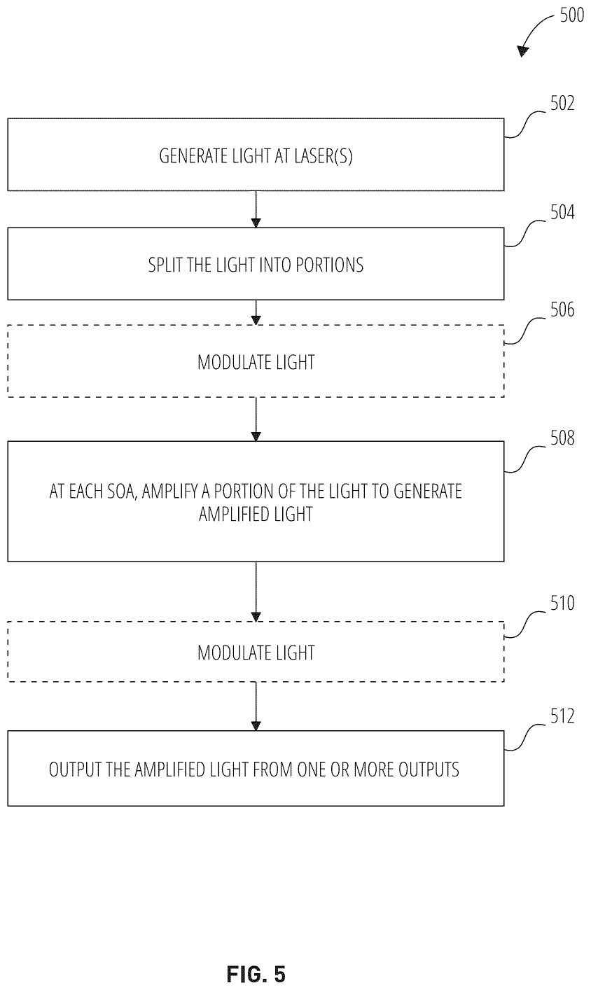

FIG. 5 shows operations of a method 500 for operating an optical transmitter having SOAs, such as the first optical transmitter 300 or second optical transmitter 400. The method 500 can also be performed by any of the optical transmitters using SOAs that are described herein.

Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

According to some examples, the method 500 includes generating light at one or more lasers at operation 502. Whereas the first optical transmitter 300 and second optical transmitter 400 each use a single laser, other examples described below use an array of multiple lasers, whose output is combined before being split into multiple portions to drive multiple lanes. The laser(s) can be internal to the device (e.g., a PIC such as a silicon photonic die 302) or external.

According to some examples, the method 500 includes splitting the light into portions at operation 504. A power splitter can be used to split the light into multiple portions. In some examples, a cascade of two or more stages of power splitters can be used to further split the light, such as the 1×2 splitter 404 followed by the pair of 1×2 splitters 406 of the second optical transmitter 400. These multiple stages can be adjacent to each other, as in the second optical transmitter 400, or they can be separated along the light paths by one or more other components, such as the modulators 312 separating the 1×2 splitter 306 from the 1×2 splitters 310 of the first optical transmitter 300.

According to some examples, the method 500 includes modulating the light at operation 506. Modulation can take place before amplification (as in the second optical transmitter 400) or after amplification (as in the first optical transmitter 300), as shown by the dashed lines around alternative modulation operations 506 and 510.

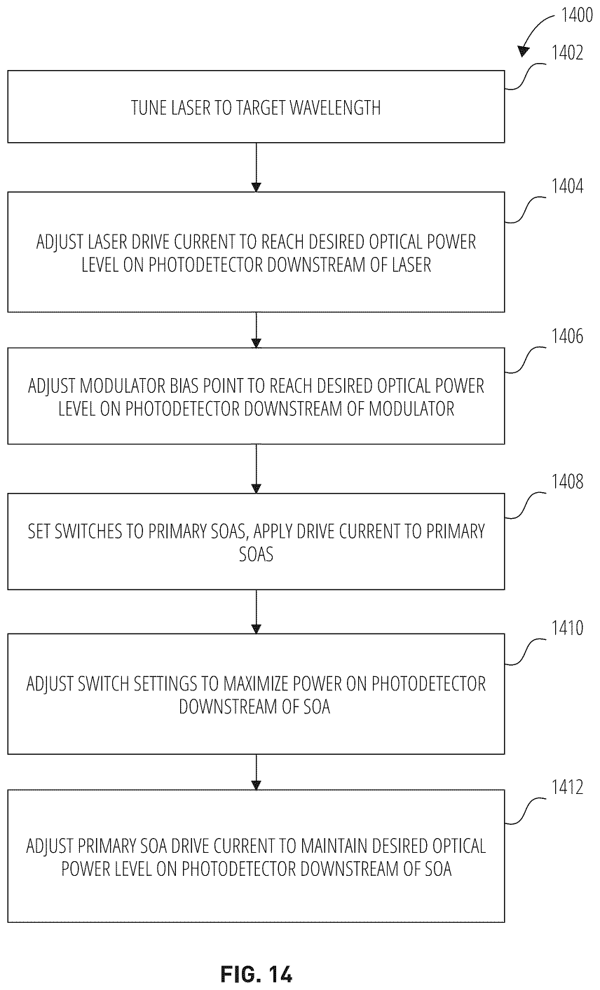

According to some examples, the method 500 includes amplifying a portion of the light at each respective SOA to generate amplified light at operation 508. Calibration and operation of the SOAs is described in greater detail below with reference to FIG. 14. The SOA performing the amplification can be a primary SOA (such as those in first optical transmitter 300 and second optical transmitter 400) or a backup SOA (such as those described in reference to various further examples below).

According to some examples, the method 500 includes modulating the light at operation 510. Operation 510 is an alternative to operation 506; each output lane is typically only modulated by a single modulator at one point along the light path. Whereas operation 506 is performed prior to amplification operation 508, alternative modulation operation 510 is performed after amplification operation 508.

According to some examples, the method 500 includes outputting the amplified light from one or more outputs at operation 512. Once the light has been split one or more times, modulated once (for each lane), and amplified (typically once in each light path from laser to output), the modulated amplified portion of light is output on a distinct lane, from a distinct output. The output of the transmitter may couple the light into an optical link, such as a fiber 314 or fiber 412.

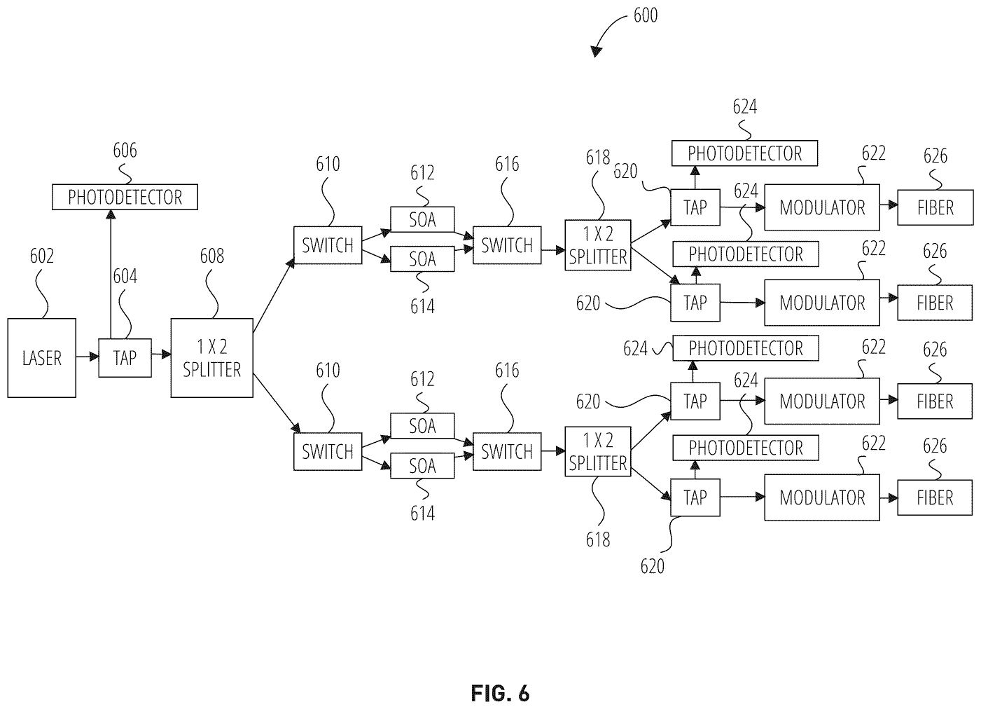

FIG. 6 shows a third optical transmitter 600 having a shared laser 602 and redundant backup SOAs 614. Any of the backup SOAs 614 can be activated in response to detecting a failure of its corresponding primary SOA 612, thereby providing redundancy for the primary SOAs, as described in greater detail below.

The third optical transmitter 600 includes a tap 604 coupled to a photodetector 606 for measuring the optical power of the output of the laser 602. Further taps 620 are coupled to further photodetectors 624 to measure the optical power of the light entering each modulator 622. The use of these photodetectors 606 and 624 is described in greater detail below; they can be used to calibrate the laser 602, to calibrate the primary SOAs 612 and backup SOAs 614, and/or to control the modulators 622.

The coherent light generated by the laser 602 is tapped by tap 604 and its optical power measured by the photodetector 606. The light is split into two portions by a 1×2 splitter 608 and routed to a pair of switches 610. The various switches used in examples described herein can be of various suitable types: for example, thermo-optic switches using a heater to actuate the switch, or electro-optic switches based on current injection (e.g., free carrier absorption) and reverse bias (e.g., Pockels effect, Kerr effect, or Quantum Confined Stark effect).

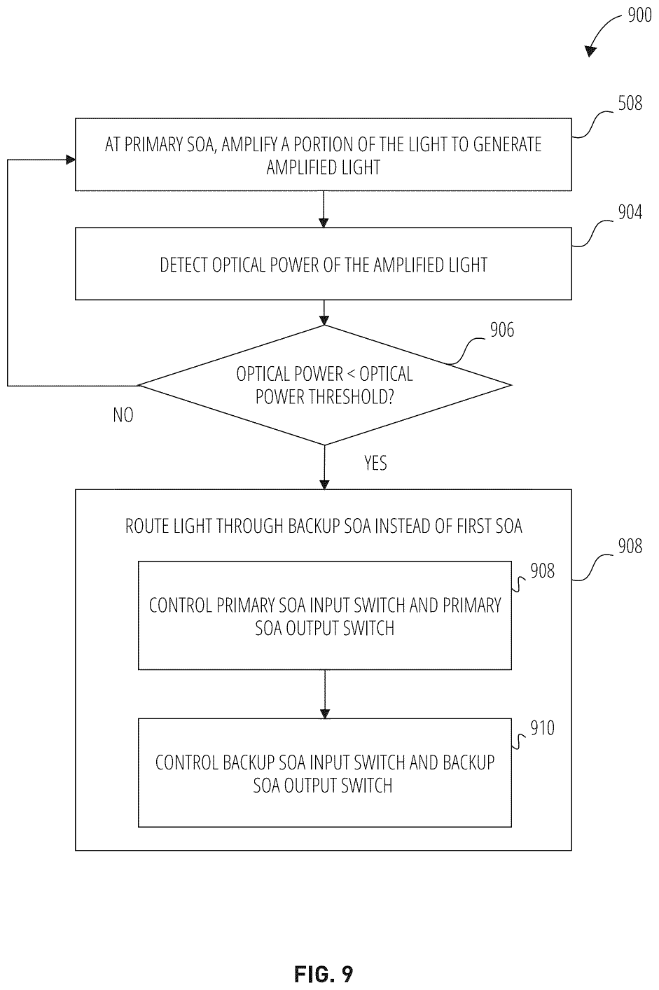

The switches 610 are each operated (e.g., by a controller as described with reference to FIG. 7 below) to switch the light path of a portion of the light between a first path passing through the primary SOA 612, and a second path passing through the corresponding backup SOA 614. A second switch 616 is positioned downstream from the primary SOA 612 and backup SOA 614; this switch 616 can also be operated to selectively activate the first path or second path. In some examples, the switch 610 and switch 616 are used to select the second path in response to detecting a failure of the primary SOA 612, as described below with reference to the method of FIG. 9.

The light received from the second switch 616 is routed to a further 1×2 splitter 618 to split each portion of the light into a further two portions, resulting in four separate lanes. Because two SOAs are used to amplify the light prior to the second set of 1×2 splitters 618, the design of the third optical transmitter 600 is analogous to that of the first optical transmitter 300.

After the second set of 1×2 splitters 618, the light is tapped by taps 620 and its optical power measured by photodetectors 624. The light on each output lane is then modulated by the modulators 622 before being propagated to the outputs for transmission on the fibers 626.

The third optical transmitter 600 can use a low-powered laser 602 due to the amplification by the SOAs, thereby extending laser lifetime. The SOAs can be driven at a high drive current to compensate for the low laser power and the pre-and post-amplification splitting; whereas this high SOA drive current can increase the chance of SOA failure, the use of backup SOAs 614 mitigates this risk and can result in a long lifetime for the device as a whole.

In various examples, the laser 602 can be an external laser or an internal laser integrated into the PIC with the other transmitter components.

In some examples, further taps and photodetectors can be included after the modulators 622.

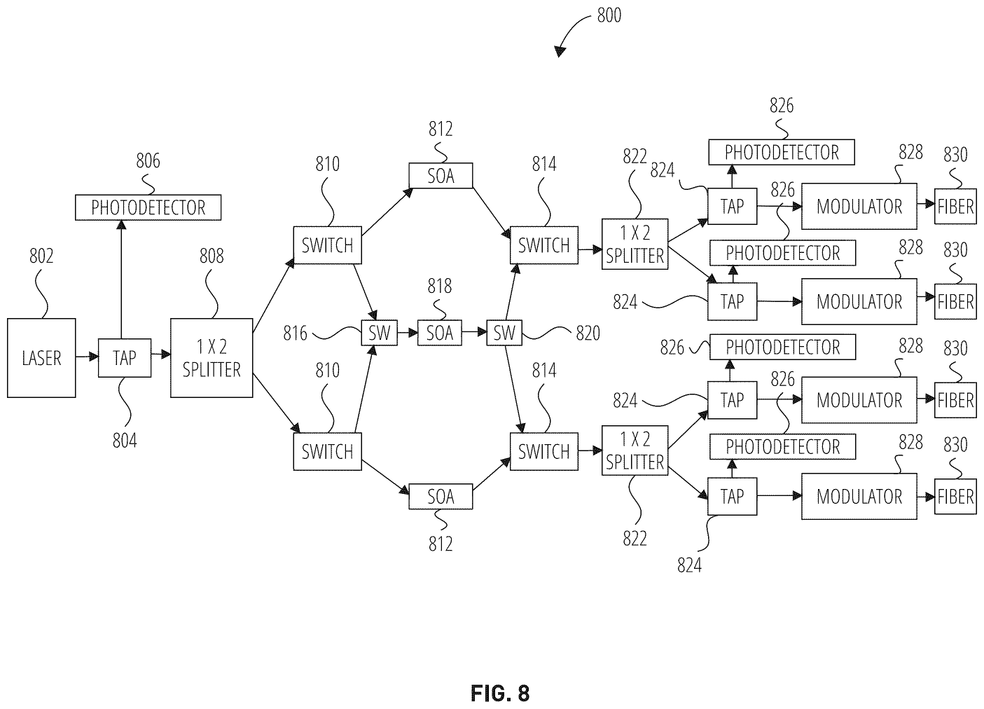

The third optical transmitter 600 shows each primary SOA 612 paired with a corresponding backup SOA 614, such that the ratio of primary SOAs 612 to backup SOAs 614 is 1:1. In some examples, backup SOAs can be distributed more thinly such that this ratio is lower, such as 1:2. However, layout constraints of the PIC may limit the ratio to at least 1:2, as pairing a single backup SOA to more than two primary SOAs may not be feasible due to layout constraints. And example of a design having a ratio of 1:2 is shown in FIG. 8 below.

FIG. 7 shows a controller 702 in communication with components of an optical transmitter, such as third optical transmitter 600. In some examples, the controller 702 can be included in the PIC or in a separate component of an optical transmitter system for receiving inputs from the photodetectors (e.g., photodetector 606 and photodetectors 624) of the optical transmitter and controlling the laser (e.g., laser 602), SOAs (e.g., primary SOAs 612 and backup SOAs 614), switches (e.g., switches 610 and switches 616), and/or modulators (e.g., modulators 622) based on these inputs. The controller 702 can be implemented as one or more suitable hardware and/or software logic components.

FIG. 8 shows a fourth optical transmitter 800 having a shared laser 802 and a shared backup SOA 818 between a pair of primary SOAs 812, such that a ratio of 1 backup SOA 818 to each 2 primary SOAs 812 is achieved.

The fourth optical transmitter 800 has the same general architecture as the third optical transmitter 600, with the exception of the arrangement of the backup SOA 818 and the switches used to activate the second light path passing through the backup SOA 818. The laser 802 output is tapped by tap 804 and measured by photodetector 806, then split by 1×2 splitter 808 to switches 810.

At this point, each switch 810 is configured to selectively propagate light through either a first path, passing through the corresponding primary SOA 812, or through a second path, which passes through the shared backup SOA 818. The second path includes not only the backup SOA 818, but also a backup SOA input switch 816 upstream from the backup SOA 818 and a backup SOA output switch 820. These switches 816 and 820 are used to select between the two primary SOA input switches 810 and between the two primary SOA output switches 814 depending on which primary SOA 812 has failed and is routing its light through the second path. (It will be appreciated that the switches providing input to SOAs, such as switch 610 or switch 810, may be referred to herein as SOA input switches, whereas the switches receiving output from the SOAs, such as switch 616 or switch 814, may be referred to as SOA output switches).

As in the third optical transmitter 600, the fourth optical transmitter 800 further splits each portion of amplified light using a second set of 1×2 splitters 822 to form four output lanes. Each lane is tapped by a tap 824 and measured by a photodetector 826 before being modulated by a modulator 828, then propagated to an output for transmission on fiber 830.

Relative to the third optical transmitter 600, the fourth optical transmitter 800 is a less complex design due to using only one backup SOA instead of two, for a total of three SOAs instead of four, although this simplification is partially offset by the need for two additional switches.

As in previous examples, the laser may be internal or external. Either the third optical transmitter 600 or the fourth optical transmitter 800 could be reconfigured in some examples to place the SOAs after the modulators; this would increase the number of SOAs and switches required and could increase power consumption, but could produce greater optical power at each output channel, as described above with reference to the second optical transmitter 400.

FIG. 9 shows operations of an example method 900 for operating an optical transmitter with backup SOAs, such as third optical transmitter 600 or fourth optical transmitter 800.

Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

According to some examples, the method 900 includes amplifying a portion of the light to generate amplified light using a primary SOA (e.g., primary SOA 612 or primary SOA 812) at operation 508. Operation 508 can be regarded as the transmitter operating in a default mode or first mode.

According to some examples, the method 900 includes detecting the optical power of the amplified light at operation 904. A photodetector placed downstream of the primary SOA (such as a modulator 622 or photodetector 826) can measure the optical power of the amplified light.

According to some examples, the method 900 includes determining whether the measured optical power is greater than an optical power threshold at operation 906. In some examples, operation 906 is performed by a controller 702 controlling the current driving the SOAs and monitoring the measurements of the photodetectors. In some examples, the optical power threshold can be defined relative to a target power level. For example, the optical power threshold can be defined as 1 dB below the target power level. If the primary SOA is being driven at its maximum drive current and the optical power measured at the photodetector at operation 904 drops below the optical power threshold, the method 900 proceeds to operation 908 to operate in a backup mode. Otherwise, the method 900 continues operating in the default mode, e.g., by returning to operation 902.

According to some examples, the method 900 includes routing light through a backup SOA (e.g., backup SOA 614 or backup SOA 818) instead of the primary SOA at operation 908. As part of operation 908, the controller 702 deactivates the primary SOA the activates the backup SOA by providing a drive current to the backup SOA instead of the primary SOA. In some examples, operation 908 also includes operation 910 and/or operation 912. In some examples, operation 908 is performed by the controller 702 controlling the switches and SOAs of the optical transmitter.

According to some examples, the method 900 includes controlling a primary SOA input switch (e.g., switch 610 or switch 810) and a primary SOA output switch (e.g., switch 616 or switch 814) at operation 908 to route the light along the second path through the primary SOA input switch to the backup SOA, and from the backup SOA through the primary SOA output switch toward one or more downstream components (e.g., 1×2 splitter 618 or 1×2 splitter 822).

According to some examples, the method 900 includes controlling a backup SOA input switch (e.g., switch 816) and a backup SOA output switch (e.g., switch 820) at operation 910. The switch 816 is controlled to route light from the primary SOA input switch of the failed primary SOA, through the switch 816, to the backup SOA. The switch 820 is similarly controlled to route light from the backup SOA, through the switch 820, to the primary SOA output switch of the failed primary SOA. Operation 910 is thus only performed in transmitters having backup SOAs that are shared by two or more primary SOAs, such as fourth optical transmitter 800.

Method 900 therefore provides a means by which failure of a primary SOA can be mitigated by switching the optical transmitter into a backup mode at operation 906. This can extend the lifetime of the device as a whole even in designs using a high drive current to amplify the laser light via SOAs.

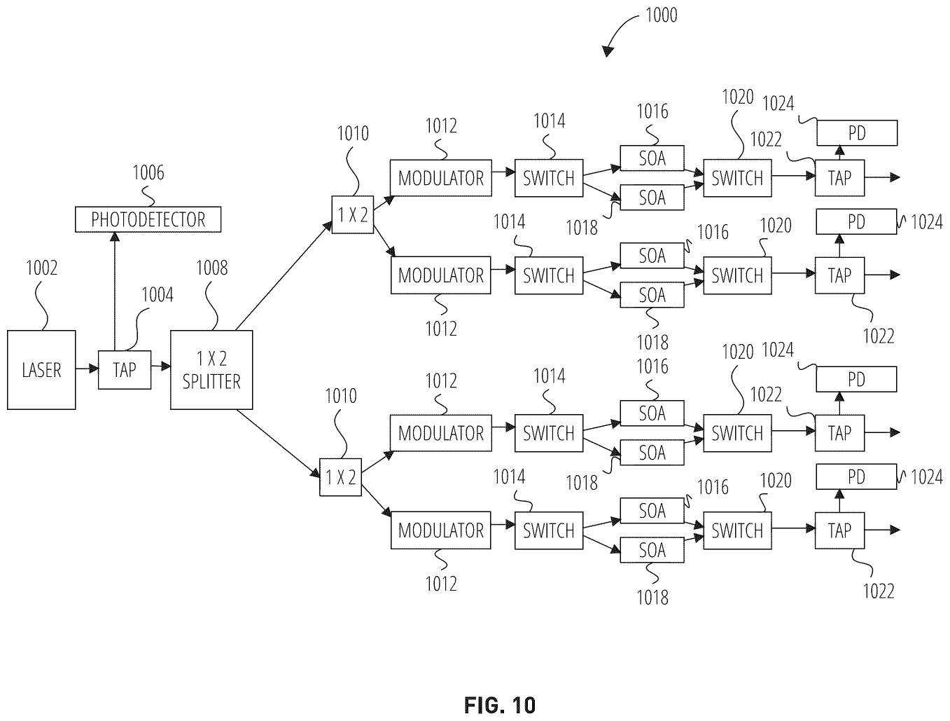

FIG. 10 shows a fifth optical transmitter 1000 having a shared laser 1002 and backup SOAs 1018 positioned after the modulators 1012. As mentioned above in reference to FIG. 4 and FIG. 8, this configuration may have the disadvantages of increasing the number of SOAs and switches required and increasing power consumption, but the advantage of producing greater optical power at each output channel.

The fifth optical transmitter 1000 has a laser 1002 (which can be internal or external), a tap 1004, a photodetector 1006, a 1×2 splitter 1008, a further pair of 1×2 splitters 1010, a set of modulators 1012, a set of primary SOA switches 1014, a set of primary SOAs 1016, a set of backup SOAs 1018, a set of primary SOA output switches 1020, a further set of taps 1022, and a further set of photodetectors 1024.

The operation of the primary SOA 1016, backup SOA 1018, and switches of each lane is analogous to those in third optical transmitter 600. However, it will be appreciated that fifth optical transmitter 1000 could be modified to instead use shared backup SOAs such as those in fourth optical transmitter 800.

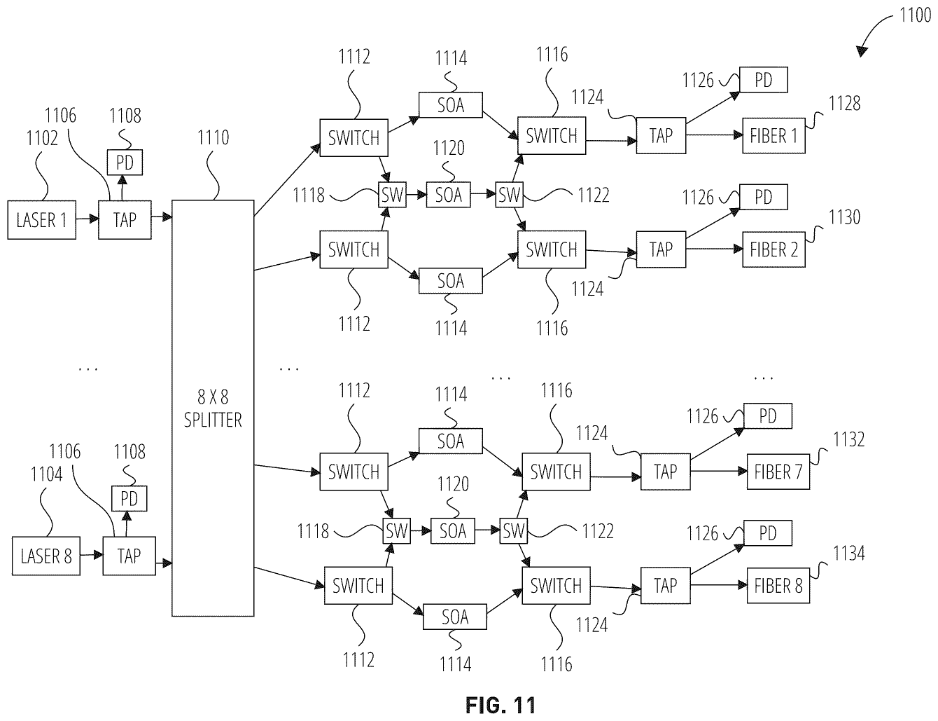

The examples shown in FIG. 1 to FIG. 4, FIG. 6, FIG. 8, and FIG. 10 can all be implemented using a pluggable optical module transmitter, in which a single optical package transmitter contains a laser and one or more modulators and connects to an optical link including one or more fibers. However, as described above, some examples can also be implemented using external lasers. External laser sources are shown in FIG. 11 through FIG. 13, described below. In designs using external lasers, the pluggable optical module may include only a laser and no modulators. These examples may differ from those described above insofar as the examples using external lasers as shown in FIG. 11 through FIG. 13 use 8 or more lasers operating at a respective 8 or more different optical wavelengths within each fiber transmitting a given output lane. Thus, each of these examples can have multiple output lanes (e.g., 8 or 16 output fibers) wherein each output lane carries light of multiple wavelengths (e.g., 8 or 16 wavelengths per fiber). The fibers can connect to the other transmitter components at a separate location, and the transmitter components may include, e.g., a wavelength demultiplexer, modulators, and a wavelength multiplexer. In some examples, these example architectures can be used in contexts in which the modulator is placed in a high temperature environment, such as next to a GPU, ASIC, or Packet Routing Switch. In these contexts, the high temperature environment next to the electronics prevents laser assembly at that location, as laser efficiency drops significant at these high temperatures. Thus, in some examples, the lasers shown in FIG. 10 through FIG. 13 can be located at a remove from modulators or other components of the optical transmitter. The examples shown in FIG. 11 through FIG. 13 can thus each be considered a pluggable laser module of an optical transmitter system.

In some examples using external laser sources, a high number of lasers are used, operating at different wavelengths at a fixed frequency spacing. The wavelengths of the lasers can shift within tolerances defined by the intended application, but in some cases the frequency spacing is maintained within tight tolerances in order for the multiplexer and demultiplexer to work correctly. High optical power may be required to compensate for the optical losses from the fiber connections from the laser to the other components, and from the wavelength demultiplexer and multiplexer.

In some examples, the backup SOAs are used in external laser source transmitters to provide higher optical power and improve the lifetime of these systems, as they may have a high number of components operating at high drive current.

FIG. 11 shows a laser module for a sixth optical transmitter 1100 having 8 external lasers (laser 1 1102 through laser 8 1104) and shared backup SOAs 1120 (as in fourth optical transmitter 800). As described above, the lasers 1102 through 1104 may all operate at different wavelengths to define a laser grid or wavelength distribution having a fixed frequency spacing. In some examples, the lasers may need to have operating wavelengths that are at least partially tunable to conform to the laser grid; this may result in somewhat lower laser power than the use of non-tunable/fixed-frequency lasers.

In some examples, the sixth optical transmitter 1100 may need to use both lasers and SOAs driven at relatively high drive current, for the reasons described above. This may limit the lifetime of the primary SOAs, a limitation that can be addressed by the use of backup SOAs.

The sixth optical transmitter 1100 thus includes an array of multiple (e.g., eight) lasers (e.g., silicon photonics lasers) operating at different operating wavelengths. Each laser has an associated tap 1106 and photodetector 1108. The outputs of all of the lasers (laser 1 1102 through laser 8 1104) are split by a power splitter, 8×8 splitter 1110, into eight portions. Each input port of the 8×8 splitter 1110 is divided to all 8 output ports of the 8×8 splitter 1110, which performs equal power splitting over all 8 laser wavelengths. (In examples described herein, the number of lasers may be denoted N, and the number of lanes may be denoted M; thus, in the sixth optical transmitter 1100, N=8 and M=8.)

Each of the N lasers thus has its output power split over M lanes. Each lane therefore has 1/M of the optical power generated by each laser. Each lane, carrying N wavelengths of light at 1/M optical power, uses a primary SOA 1114 arranged in parallel with a backup SOA 1120 shared between each two lanes, and selectively activated using an arrangement of switches 1112, 1118, 1122, and 1116, to amplify the optical power on all wavelengths. The shared backup SOAs are operated as those of the fourth optical transmitter 800 described above.

Each lane has a tap 1124 coupled to a further photodetector 1126 to measure the amplified light in each lane. The amplified light is then propagated to an output for each lane and transmitted on eight fibers for the eight lanes: fiber 1 1128, fiber 2 1130, and so on through fiber 7 1132 and fiber 8 1134.

In some examples, the sixth optical transmitter 1100 is used in conjunction with a remote temperature controlled laser module (e.g., laser 1 1102 through laser 8 1104)) located in one part of the system, and non-temperature controlled modulators and detectors in a separate part of the system. The non-temperature controlled components may be packaged next to a GPU, HBM, or large IC chip to route data into and out of that package. The laser modulator may connect to a high-count fiber array that brings multiple wavelengths and multiple fibers to the modulator and detector chips. Thus, the sixth optical transmitter 1100 as illustrated does not include modulators, as the modulators may be located in a separate package located remotely from the sixth optical transmitter 1100.

It will be appreciated that, in some examples, the number of fibers and lasers need not match, in other words, N may not be equal to M.

Because of the large number of lasers used by the sixth optical transmitter 1100, some examples may integrate the lasers 1102 through 1104 into the same package of PIC as the other components shown in the sixth optical transmitter 1100. The sixth optical transmitter 1100 may therefore define a laser module for a transmitter, in which the modulator components of the transmitter are located elsewhere. Using multiple external lasers to supply inputs to the 8×8 splitter 1110 could require multiple optical couplings, potentially complicating the design.

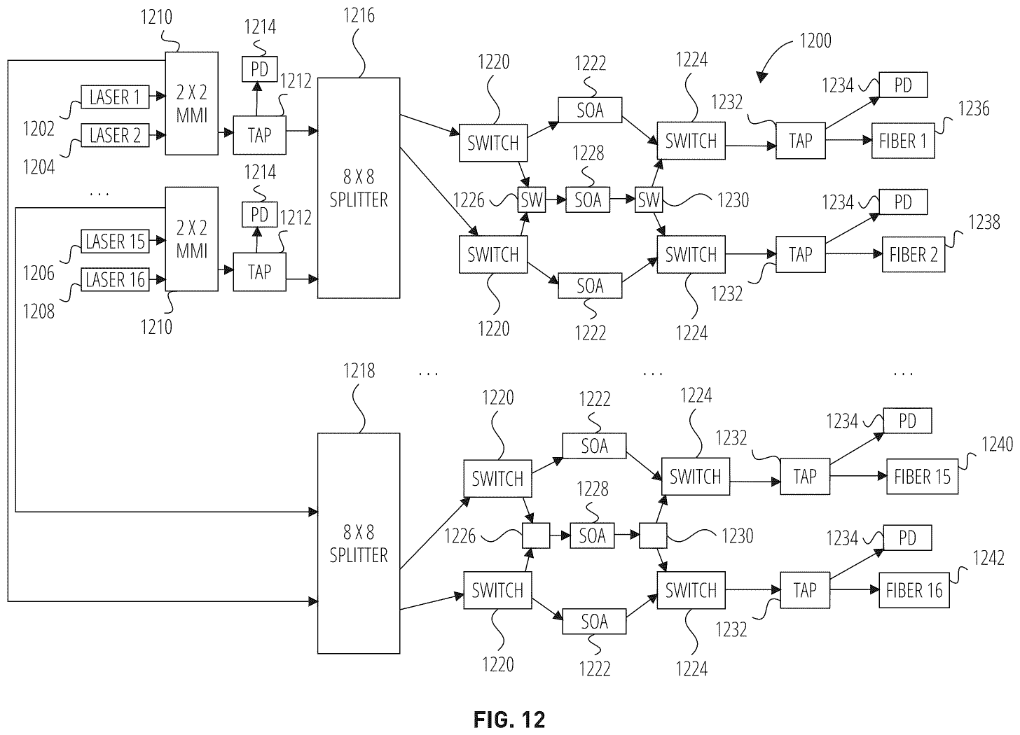

FIG. 12 shows a laser module for a seventh optical transmitter 1200 having 16 external lasers (laser 1 1202, laser 2 1204, and so on through laser 15 1206 and laser 16 1208) and shared backup SOAs 1228.

The architecture of the lanes following the power splitter is analogous to that of sixth optical transmitter 1100: pair of primary SOAs 1222 sharing a common shared backup SOA 1228, operated by an arrangement of switches 1220, 1226, 1230, 1224, taps 1232 and photodetectors 1234, and fibers fiber 1 1236, fiber 2 1238, and so on through fiber 15 1240 and fiber 16 1242.

However, seventh optical transmitter 1200 differs from sixth optical transmitter 1100 insofar as it uses N=16 lasers instead of the N=8 lasers of sixth optical transmitter 1100. Because 8×8 may represent a reasonable upper limit for power splitting, seventh optical transmitter 1200 therefore uses two separate 8×8 splitters 1216 and 1218, each of which receives a set of 8 inputs from a set of eight multi-mode interferometers (2×2 MMI 1210) each having two inputs and two outputs. A first 2×2 MMI 1210 pre-mixes the light generated by the first pair of lasers (laser 1 1102 and laser 8 1104). Each subsequent pair of adjacent lasers has its own respective 2×2 MMI 1210, through a final 2×2 MMI 1210 pre-mixing the light generated by the last pair of lasers (laser 15 1206 and laser 16 1208). The output of each 2×2 MMI 1210 is tapped by a respective tap 1212 coupled to a photodetector 1214.

The first output of each of the eight 2×2 MMIs 1210 is routed to the first 8×8 splitter 1216 and split into a first eight lanes, each having light of all sixteen laser wavelengths. The second output of each of the eight 2×2 MMIs 1210 is routed to the second 8×8 splitter 1218 and split into a second eight lanes, each having light of all sixteen laser wavelengths. Thus, the seventh optical transmitter 1200 has 16 output lanes, each of which carries 16 wavelengths of light.

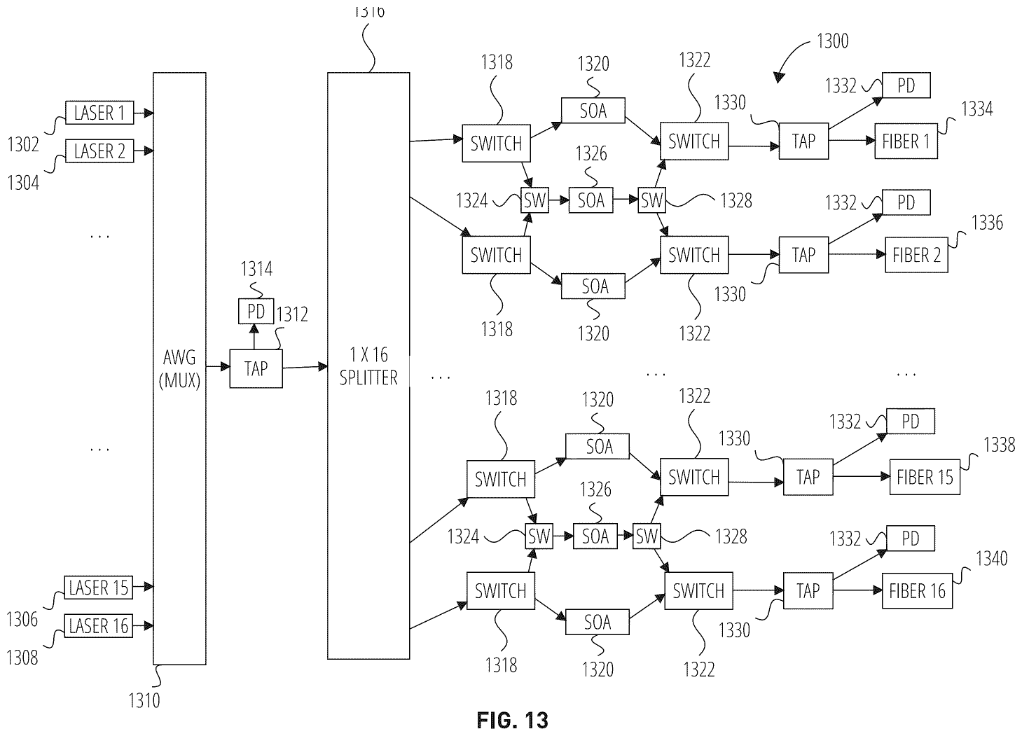

FIG. 13 shows a laser module for an eighth optical transmitter 1300 having 16 external lasers (laser 1 1302, laser 2 1304, and so on through laser 15 1306 and laser 16 1308), a multiplexer (AWG (MUX) 1310), and shared backup SOAs 1326.

In this example, the lasers (e.g., N=16 silicon photonics lasers) each operate at a fixed frequency spacing and different wavelengths. All laser outputs are routed to a wavelength multiplexer, such as an arrayed waveguide grating AWG (MUX) 1310, to combine the N laser outputs onto a single lane. The output of the AWG (MUX) 1310 goes to a 1×M power splitter (in this example, 1×16 splitter 1316) to split the multiplexed light onto M lanes. Each lane after the power splitter carries 1/M of the power from each laser. The N wavelengths of light carried by each lane is amplified by an SOA (primary SOA 1320 in parallel with shared backup SOA 1326 with associated switches 1318, 1324, 1328, 1322) to amplify the optical power of the lane on all wavelengths. Fiber 1 1334, fiber 2 1336, and so on through fiber 15 1338 and fiber 16 1340 transmit the output to another device, e.g., a non-temperature controlled modulator package. Taps 1312 and 1330, and associated photodetectors 1314 and 1332, are used to monitor optical power output by the AWG (MUX) 1310 and the switches 1322. The power tap 1312 and photodetector 1314 placed after the wavelength multiplexer AWG (MUX) 1310 can be used to measure the alignment of the lasers to the multiplexer. Adjustments can be made to each laser to maintain alignment during operation.

In some examples, the AWG (MUX) 1310 is a silicon or silicon nitride arrayed waveguide grating (AWG), which is a type of wavelength multiplexer. All lasers are multiplexed in the AWG to a single output power. The AWG output port uses the tap 1312 to align all of the lasers to the AWG channels. Power is then split into 16 portions (M=16 in this example) and amplified by SOAs.

As in the sixth optical transmitter 1100 and seventh optical transmitter 1200, using integrated lasers avoids the need to couple and align all of the lasers to the inputs (e.g., AWG (MUX) 1310 inputs, 2×2 MMI 1210 inputs, or 8×8 splitter 1110 inputs). However, some examples may use an external module for the lasers and AWG (MUX) 1310, which provides only a single output that can be coupled and aligned to the input of a separate module containing the 1×16 splitter 1316 and other downstream components.

FIG. 14 illustrates operations of a method 1400 for calibrating and operating an optical transmitter with SOAs. In some examples, the method 1400 can be performed or controlled by a controller 702 of an optical transmitter, an optical transmitter system, or a laser module of an optical transmitter system.

Although the example method 1400 depicts a particular sequence of operations, the sequence may be altered without departing from the scope of the present disclosure. For example, some of the operations depicted may be performed in parallel or in a different sequence that does not materially affect the function of the method 1400. In other examples, different components of an example device or system that implements the method 1400 may perform functions at substantially the same time or in a specific sequence.

According to some examples, the method 1400 includes tuning each laser to its target wavelength at operation 1402. Each laser can be tuned serially or in parallel. For a given laser, the laser is turned on and tuned to the intended wavelength (e.g., a wavelength determined by the laser grid). In the case of the eighth optical transmitter 1300, the laser wavelength may be tuned based on the measurements of the photodetector 1314. In other examples, the laser may be tuned based on the output of the photodetector placed downstream from the laser and upstream from any SOAs or modulators.

According to some examples, the method 1400 includes adjusting each laser drive current to reach a desired optical power level as detected by a photodetector downstream of the laser at block 1404. The same photodetector used in operation 1402 is also used to adjust the drive current of the laser to reach the desired optical power level. Once a laser has been tuned and its drive current adjusted, the laser calibration settings may be saved, e.g., to a memory coupled to or included in the controller 702.

After all lasers have been calibrated, the eighth optical transmitter 1300 and other examples using a multiplexer may require a further operation (not shown) to calibrate the AWG (MUX) 1310. All lasers are turned on, and different dither frequencies (e.g., small amplitude, slowly varying) are applied to each laser. Lock-in techniques can be used to extract the power of each laser from the signal of the photodetector 1314 (e.g., by applying a 100 Hz small-amplitude signal to laser 1 1302 and measuring 100 Hz amplitude at photodetector 1314, then repeating for each other laser). The wavelength of each laser is then fine-tuned to maximize the optical power measured at the photodetector 1314.

According to some examples, the method 1400 includes adjusting a modulator bias point to reach a desired optical power level as detected by a photodetector downstream of a modulator (e.g., photodetector 1024 downstream of modulator 1012, or other modulation photodetectors not shown in the various examples) at operation 1406. This operation 1406 can be performed for each modulator of a transmitter (e.g., modulators 408) or each modulator of a separate modulator package (e.g., for sixth optical transmitter 1100, seventh optical transmitter 1200, or eighth optical transmitter 1300).

According to some examples, the method 1400 includes setting one or more switches to route light through the primary SOAs and applying drive currents to the primary SOAs at operation 1408. In default mode operation, the backup SOAs are deactivated, and the switches are all configured to route light through the first path for each lane, such that light propagates through the primary SOA instead of the backup SOA.

According to some examples, the method 1400 includes adjusting switch settings to maximize the optical power on photodetectors downstream from the SOAs at operation 1410. For example, the settings of switches 1014 and 1020 can be adjusted to maximize the optical power of light detected by the photodetectors 1024 of fifth optical transmitter 1000.

According to some examples, the method 1400 includes adjusting the primary SOA drive current to maintain the desired optical power level on the photodetector downstream from SOA at operation 1412. The current used to drive each primary SOA (in default mode) or each backup SOA (in backup mode for a given lane) can be adjusted to maintain the desired optical power level.

Other examples of optical devices, systems, and methods may include features, and combinations or subcombinations of features, of the various examples described herein.

In view of the disclosure above, various examples are set forth below. It should be noted that one or more features of an example, taken in isolation or combination, should be considered within the disclosure of this application.

The following are examples:

Example 1 is an optical transmitter, comprising: an optical splitter configured to receive light generated by at least one laser and split the light into a plurality of portions; a plurality of semiconductor optical amplifiers (SOAs), each SOA of the plurality of SOAs being configured to: receive a respective portion of the plurality of portions of the light; and amplify the respective portion of the light to generate amplified light; and a plurality of outputs, each output of the plurality of outputs being configured to output at least a portion of the amplified light generated by a respective SOA.

In Example 2, the subject matter of Example 1 comprises, a plurality of modulators, each modulator of the plurality of modulators being configured to modulate light propagating between the optical splitter and a respective one of the outputs.

In Example 3, the subject matter of Example 2 comprises, wherein: the plurality of modulators comprises at least two modulators modulating respective sub-portions of the amplified light generated by a single common SOA.

In Example 4, the subject matter of Examples 1-3 comprises, the at least one laser.

In Example 5, the subject matter of Examples 1-4 comprises, wherein: the at least one laser is one laser operating at a single wavelength.

In Example 6, the subject matter of Examples 1-5 comprises, wherein: the at least one laser comprises a plurality of lasers operating at a respective plurality of different wavelengths.

In Example 7, the subject matter of Examples 1-6 comprises, a plurality of photodetectors for detecting optical power of light at a respective plurality of locations within the optical transmitter; and a controller for controlling gain applied to the light by the plurality of SOAs based on the detected optical power.

In Example 8, the subject matter of Examples 1-7 comprises, a backup SOA for modulating light following a failure of a primary SOA of the plurality of SOAs; and a switch for selectively routing light through either of the primary SOA or the backup SOA.

In Example 9, the subject matter of Example 8 comprises, a photodetector configured to detect optical power of the amplified light generated by the primary SOA; and a controller configured to: in response to detecting that the optical power of the amplified light generated by the primary SOA is below an optical power threshold, controlling the switch to route light through the backup SOA instead of the primary SOA.

In Example 10, the subject matter of Examples 1-9 comprises, at least one multiplexer configured to multiplex the light generated by the at least one laser to generate multiplexed light; wherein the optical splitter receiving and splitting the light generated by the at least one laser comprises receiving the multiplexed light and splitting the multiplexed light into a plurality of portions.

Example 11 is a method, comprising: receiving light generated by at least one laser; splitting the light into a plurality of portions; at each of a plurality of semiconductor optical amplifiers (SOAs), amplifying a respective portion of the light to generate respective amplified light; and outputting the amplified light generated by a respective SOA from a respective one or more outputs.

In Example 12, the subject matter of Example 11 comprises, at each modulator of a plurality of modulators, modulating light after the light is split and before the light is output.

In Example 13, the subject matter of Example 12 comprises, wherein: the plurality of modulators comprises at least two modulators modulating respective sub-portions of the amplified light generated by a single common SOA.

In Example 14, the subject matter of Examples 11-13 comprises, generating the light at the at least one laser.

In Example 15, the subject matter of Examples 11-14 comprises, wherein: the at least one laser is one laser operating at a single wavelength.

In Example 16, the subject matter of Examples 11-15 comprises, wherein: the at least one laser comprises a plurality of lasers operating at a respective plurality of different wavelengths.

In Example 17, the subject matter of Examples 11-16 comprises, detecting optical power of the amplified light; and controlling gain applied to the light by the plurality of SOAs based on the detected optical power.

In Example 18, the subject matter of Examples 11-17 comprises, detecting optical power of the amplified light generated by a primary SOA of the plurality of SOAs; and in response to detecting that the optical power of the amplified light generated by the primary SOA is below an optical power threshold, routing light through a backup SOA instead of the primary SOA.

Example 19 is a system comprising: at least one laser configured to generate light; an optical splitter configured to receive the light and split the light into a plurality of portions; a plurality of semiconductor optical amplifiers (SOAs), each SOA of the plurality of SOAs being configured to: receive a respective portion of the plurality of portions of the light; and amplify the respective portion of the light to generate amplified light; and a plurality of outputs, each output of the plurality of outputs being configured to output at least a portion of the amplified light generated by a respective SOA.

In Example 20, the subject matter of Example 19 comprises, a plurality of modulators, each modulator of the plurality of modulators being configured to modulate light propagating between the optical splitter and a respective one of the outputs.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. An optical transmitter, comprising:
an optical splitter configured to receive light generated by at least one laser and split the light into a plurality of portions; and
a plurality of semiconductor optical amplifiers (SOAs), each SOA of the plurality of SOAs being configured to:
receive a respective portion of the plurality of portions of the light; and
amplify the respective portion of the light to generate amplified light; and
a plurality of outputs, each output of the plurality of outputs being configured to output at least a portion of the amplified light generated by a respective SOA.

2. The optical transmitter of claim 1, further comprising:
a plurality of modulators, each modulator of the plurality of modulators being configured to modulate light propagating between the optical splitter and a respective one of the outputs.

3. The optical transmitter of claim 2, wherein:
the plurality of modulators comprises at least two modulators modulating respective sub-portions of the amplified light generated by a single common SOA.

4. The optical transmitter of claim 1, further comprising:
the at least one laser.

5. The optical transmitter of claim 1, wherein:
the at least one laser is one laser operating at a single wavelength.

6. The optical transmitter of claim 1, wherein:
the at least one laser comprises a plurality of lasers operating at a respective plurality of different wavelengths.

7. The optical transmitter of claim 1, further comprising:
a plurality of photodetectors for detecting optical power of light at a respective plurality of locations within the optical transmitter; and
a controller for controlling gain applied to the light by the plurality of SOAs based on the detected optical power.

8. The optical transmitter of claim 1, further comprising:
a backup SOA for modulating light following a failure of a primary SOA of the plurality of SOAs; and
a switch for selectively routing light through either of the primary SOA or the backup SOA.

9. The optical transmitter of claim 8, further comprising:
a photodetector configured to detect optical power of the amplified light generated by the primary SOA; and
a controller configured to:
in response to detecting that the optical power of the amplified light generated by the primary SOA is below an optical power threshold, controlling the switch to route light through the backup SOA instead of the primary SOA.

10. The optical transmitter of claim 1, further comprising:
at least one multiplexer configured to multiplex the light generated by the at least one laser to generate multiplexed light;
wherein the optical splitter receiving and splitting the light generated by the at least one laser comprises receiving the multiplexed light and splitting the multiplexed light into a plurality of portions.

11. A method, comprising:
receiving light generated by at least one laser;
splitting the light into a plurality of portions;
at each of a plurality of semiconductor optical amplifiers (SOAs), amplifying a respective portion of the light to generate respective amplified light; and
outputting the amplified light generated by a respective SOA from a respective one or more outputs.

12. The method of claim 11, further comprising:
at each modulator of a plurality of modulators, modulating light after the light is split and before the light is output.

13. The method of claim 12, wherein:
the plurality of modulators comprises at least two modulators modulating respective sub-portions of the amplified light generated by a single common SOA.

14. The method of claim 11, further comprising:
generating the light at the at least one laser.

15. The method of claim 11, wherein:
the at least one laser is one laser operating at a single wavelength.

16. The method of claim 11, wherein:
the at least one laser comprises a plurality of lasers operating at a respective plurality of different wavelengths.

17. The method of claim 11, further comprising:
detecting optical power of the amplified light; and
controlling gain applied to the light by the plurality of SOAs based on the detected optical power.

18. The method of claim 11, further comprising:
detecting optical power of the amplified light generated by a primary SOA of the plurality of SOAs; and
in response to detecting that the optical power of the amplified light generated by the primary SOA is below an optical power threshold, routing light through a backup SOA instead of the primary SOA.

19. A system comprising:
at least one laser configured to generate light;
an optical splitter configured to receive the light and split the light into a plurality of portions;
a plurality of semiconductor optical amplifiers (SOAs), each SOA of the plurality of SOAs being configured to:
receive a respective portion of the plurality of portions of the light; and
amplify the respective portion of the light to generate amplified light; and
a plurality of outputs, each output of the plurality of outputs being configured to output at least a portion of the amplified light generated by a respective SOA.

20. The system of claim 19, further comprising:
a plurality of modulators, each modulator of the plurality of modulators being configured to modulate light propagating between the optical splitter and a respective one of the outputs.
